(19) United States
(12) Patent Application Publication
(10) Pub. No.: US 2024/0344914 A1
(43) Pub. Date: Oct. 17, 2024

(54) DEVICE AND METHOD FOR LEAK TESTING AND/OR LEAKAGE MEASUREMENT OF A COMPONENT

(71) Applicant: Pfeiffer Vacuum Technology AG, Asslar (DE)

(72) Inventors: Dominik KRAHL, Nebelschuetz (DE); Alexander ARNDT, Zwickau (DE); Philipp SCHURIG, Linden (DE); Rudolf KONWITSCHNY, Landshut (DE); Maik JACOB, Radeburg (DE)

(73) Assignee: Pfeiffer Vacuum Technology AG, Asslar (DE)

(21) Appl. No.: 18/631,148

(22) Filed: Apr. 10, 2024

(30) Foreign Application Priority Data
Apr. 13, 2023 (EP) 23167812.9

(51) Int. Cl. G01M 3/02; G01M 3/20; G01M 3/32; G01M 3/38

(52) U.S. Cl. CPC G01M 3/02; G01M 3/202; G01M 3/3227; G01M 3/3254; G01M 3/3263; G01M 3/38

(57) ABSTRACT

A method is for the leak testing and/or leakage measurement of a component with a plurality of channels. The method includes applying a predefined input state to an input configuration of channels of the component, measuring an output state at an output configuration of channels of the component, and determining a leakage state and/or a leakage rate of the component based on the measurement. The input configuration has at least two channels of the component and the output configuration has at least one other channel of the component, or the input configuration has at least one channel of the component and the output configuration has at least two other channels of the component

The present invention relates to an apparatus for the leak testing and/or leakage measurement of a component. The invention also relates to a method for the leak testing and/or leakage measurement of a component.

Channel-containing components (i.e. components comprising at least one channel) can be used in various applications. For example, the channel-containing components can be bipolar plates. Bipolar plates are components of fuel cells. Within the meaning of the invention, a fuel cell known per se is understood as an apparatus that is capable of converting a portion of the energy from the reaction of an oxidizing agent (e.g. oxygen) with a reducing agent (e.g. hydrogen) directly into electrical energy. On the one hand, the leak-tightness or freedom from leakage of such components may be necessary to ensure a proper functioning of the component. On the other hand, leaks can also pose risks. For example, hydrogen escaping from a fuel cell in combination with oxygen from the environment or with oxygen escaping from the fuel cell through another leak could cause explosions. Technical devices that usually work with highly flammable media are subject to high safety standards and corresponding norms.

It is therefore necessary to check such components reliably and efficiently for leaks and to carry out leakage measurements.

In an exemplary apparatus for leak testing from the prior art, each channel is measured individually. The leak-tightness or leakage rate is therefore successively determined or measured separately for each channel. Furthermore, if a leak is recognized, it must be determined where the leakage leads (i.e., for example, into a channel or into which other channel or into a surrounding volume). Different apparatus for carrying out the leak test and leakage measurement are therefore required for different types of components that differ by the arrangement of the channels and in particular the arrangement of the channel inputs and outputs. It is therefore not possible in the prior art to test different components with a single apparatus. Furthermore, in the prior art, the testing usually takes a very long time since measurements take place separately for each channel.

It is an object of the invention to provide a method and an apparatus with which various components and in particular the channels formed in the components can be efficiently tested for leaks or leakage.

This object is satisfied by a method for the leak testing and/or leakage measurement of a component having the features of claim 1, and in particular in that the method comprises: applying a predefined input state to an input configuration of channels of the component; measuring an output state at an output configuration of channels of the component; and determining a leakage state and/or a leakage rate of the component based on the measurement. In this respect, the input configuration can have at least two channels of the component and the output configuration can have at least one other channel of the component, or the input configuration can have at least one channel of the component and the output configuration can have at least two other channels of the component.

Leakage measurement can in this respect include measuring or determining a leakage rate (i.e. a quantitative measurement of the size of the leak) and/or measuring or determining a leakage path (i.e. information on whether a leak e.g. exists to another channel or into a surrounding volume, i.e. out of the component). The leakage rate is in this respect a measurement variable (which is therefore measured directly or indirectly) and leak-tightness is a test variable (which is therefore derived from other measurements). For example, the component can be described as functionally tight (i.e. having leak-tightness) if there is a measured leakage rate of 0 in all the channels or channel combinations.

For the sake of completeness, it should be mentioned at this point that the specification of a leakage rate of 0 in accordance with DIN EN 1779 is impermissible in practice. Therefore, in practice, a component is described as functionally tight if it has a leakage rate that is lower than the respective maximum permissible leakage rate. In this respect, the maximum permissible leakage rate is a property of the component and is often specified as such.

A combination of an input configuration with an output configuration can be referred to as a measurement configuration. A measurement configuration can be described as “influence-free” if no channel occurs both in the input configuration and in the output configuration; a measurement based on such a measurement configuration is thus free of influences between the channels if the components are fault-free.

The input state can be a state that is common or the same for all the channels from the input configuration, for example, a predefined pressure of a certain gaseous substance. The output state can be jointly measured for all the channels from the output configuration.

For components without a leak, the output state will be independent of the input state in the case of influence-free measurement configurations. If the output state changes when the predefined input state is changed, a leak can be inferred; in particular, a leak can then be recognized between at least one channel from the input configuration and one channel from the output configuration.

In other words, a method is provided that enables the measurement of leakage rates and/or the leak testing of channel-containing components and of channels of channel-containing components. In particular, it can be checked whether the component has a channel with a leak or whether all the channels of the component are leak-tight. It can furthermore be determined where a leakage occurs, i.e., for example, whether a leakage to another channel or into a surrounding volume occurs. The method according to the invention enables a quantitative, integral leak test of channel-containing test objects.

With the method according to the invention, a significant reduction in measurement times can be achieved. This is in particular achieved by simultaneously measuring a plurality of channels. If it then turns out that the plurality of channels are leak-tight as a whole, each individual channel of the plurality of channels is leak-tight. By measuring several combinations of channels, the leak-tightness can even be checked for each individual channel and/or the leakage rate and/or the leakage path can be determined.

The measurement configurations (i.e. the respective combinations of input configuration and output configuration) can be selected such that no channel of the component is provided in the input configuration (i.e. as input) and simultaneously in the output configuration (i.e. as output). Thus, among all possible combinations of channels, only the combinations of channels that are suitable as candidates for measurements are examined.

In one embodiment, the input state comprises a predefined pressure and/or a predefined concentration and/or a predefined chemical element and/or a predefined chemical compound and/or a predefined mixture of chemical substances; and the measurement of the output state comprises detecting a pressure and/or a concentration and/or the predefined chemical element and/or the predefined chemical compound and/or the predefined mixture of chemical substances. The predefined input state therefore corresponds to the measured output state in that, in the case of a component with a leaking channel in the input configuration, a change of the output state up to the predefined input state occurs if the leaking channel in the input configuration is leaking up to a channel from the output configuration.

In one embodiment, the application and the measurement are performed for a plurality of different measurement configurations, wherein each measurement configuration has a specific input configuration (which may be different for different measurement configurations) and a specific output configuration (which may be different for different measurement configurations), and the leakage state and/or the leakage rate of the component is/are determined based on the application and the measurement for the plurality of different measurement configurations. As can be seen, measurements are therefore taken for different measurement configurations.

In one embodiment, the respective input state can have different pressures and/or different concentrations and/or different chemical elements and/or different chemical compounds and/or different mixtures of chemical substances for consecutive measurements.

The use of different elements, compounds or mixtures enables a rapid sequence of the measurements since any medium still remaining in the apparatus or in the component does not have to be considered in a subsequent measurement since a different medium (i.e. a different element, compound or mixture) is used.

The use of different pressures or concentrations makes it possible to distinguish consecutive measurements based on the differences in the pressures or in the concentration of the medium so that a rapid sequence of measurements is possible.

The measurement configurations can be selected such that the channels of the input configuration are complementary to the channels of the output configuration. As can be seen, no channel therefore occurs in both the input configuration and the output configuration. According to an embodiment, the totality of these possible measurement configurations is not examined, but rather only a subset can be examined that is selected such that all relevant leakage paths can be measured.

In one embodiment, the plurality of different measurement configurations is determined such that each channel occurs in combination with every other channel in at least one measurement configuration of the plurality of measurement configurations. Thus, each leakage path is included in at least one measurement configuration, i.e. each leakage path leads to a detectable leakage in at least one measurement configuration. The occurrence of two channels in combination means that one of the channels occurs in the input configuration, while the other channel occurs in the output configuration.

In one embodiment, a respective leakage rate is determined for the plurality of measurement configurations and a leakage rate between two channels is determined based on the respective leakage rates for the plurality of measurement configurations. Thus, the leakage rate between two individual channels can then be inferred from measurements for different measurement configurations.

The object of the invention is also satisfied by an apparatus for the leak testing and/or leakage measurement of a component having the features of claim 7, and in particular in that the apparatus has: an input; an output; a pick-up device configured to pick up the component, connect the input to an input configuration of channels of the component, and connect the output to an output configuration of channels of the component; and a measurement device configured to: apply a predefined input state to the input, measure an output state at the output, and determine a leakage state and/or a leakage rate of the component based on the measurement, wherein the input configuration has at least two channels of the component and the output configuration has at least one other channel of the component, or wherein the input configuration has at least one channel of the component and the output configuration has at least two other channels of the component.

The apparatus can further have a closure element, wherein the pick-up element and the closure element are configured to form a common sealing surface, and wherein the pick-up element and the closure element are arranged as releasably movable relative to one another. As can be seen, the apparatus can thus be opened, the component can be placed in the pick-up element and the apparatus can then be closed again by means of the closure element.

The apparatus can further have a pressure element that can be configured to connect the component to the pick-up element by exerting force on the component towards the pick-up element. For example, pressure acts on the pressure element, resulting in a force on the component. The pressure element can be designed in the form of a piston and can thus enable a thickness-independent clamping of the component; furthermore, the pressure element can thus provide a variable force which the component experiences through the pressure element and the pick-up element.

The apparatus can have an adapter plate comprising connections, which are specific to the component, of channels of the component to the input and the output. Thus, different components that differ, for example, in their external geometry and/or the position and/or the number of channels or channel openings can be used in the apparatus.

In one embodiment, the apparatus is configured to pressurize and/or evacuate internal channels of the component.

In one embodiment, the apparatus can include valves that are configured to block or release a connection between the input of the apparatus and channels of the component and between the output of the apparatus and channels of the component. The valves can be arranged in or at the adapter plate or in or at the pick-up unit or outside. The valves can be set to block or release so that the channels of the component that are required in the input configuration are connected to the input and all other channels are not connected to the input. Furthermore, the valves can be set to block or release so that the channels of the component that are required in the output configuration are connected to the output and all other channels are not connected to the output. “Connected” can here be understood as permeable to a medium (for example a chemical element, a chemical compound, or a mixture of chemical substances) and “not connected” can be understood as not permeable to the medium.

The measurement device can be a quadrupole mass spectrometer and/or a time-of-flight mass spectrometer and/or a sector field mass spectrometer and/or a pressure measurement device and/or a differential pressure measurement device and/or a flow measurement apparatus and/or a spectrometer from the group of optical spectrometers or include a corresponding device.

The measurement device can be configured to measure pressure ranges in the range of 10⁻⁷ hPa and 5 MPa, or in the range of 10⁻⁶ hPa and 4.5 MPa, or in the range of 10⁻⁴ hPa and 4 MPa.

The measurement device can be configured to measure gaseous media, preferably selected from gaseous refrigerants, ammonia, hydrocarbons, fluorinated hydrocarbons, hydrofluoroolefins, water vapor, nitrogen, air and oxygen and from test gases that have a molar mass of 4 u or 3 u or 2 u.

The channel-containing component can include or be a bipolar plate, for example a graphitic bipolar plate, or a monoplate.

The invention enables a leakage measurement and/or leak test of channel-containing components.

The method according to the invention and the apparatus according to the invention can be adapted to the component to be tested, which can also be referred to as the test specimen, for example by using the adapter plate and suitable valve positions, without a completely new method or a completely new apparatus being required.

The method according to the invention and the apparatus according to the invention can be used for the leak testing and leakage path measurement at bipolar plates. Further areas of application include monoplates, heat exchangers and all test objects with more than one test chamber and where the sequential use of several test gases saves process steps, such as applications involving post-evacuation and flushing.

The aspects of the invention described herein, i.e. the apparatus for the leak testing and/or leakage measurement of a component, on the one hand, and the method for the leak testing and/or leakage measurement of a component, on the other hand, can be advantageously further developed within the meaning of all the embodiments described for the respective other aspect.

The invention is explained only by way of example below with reference to the schematic drawing.

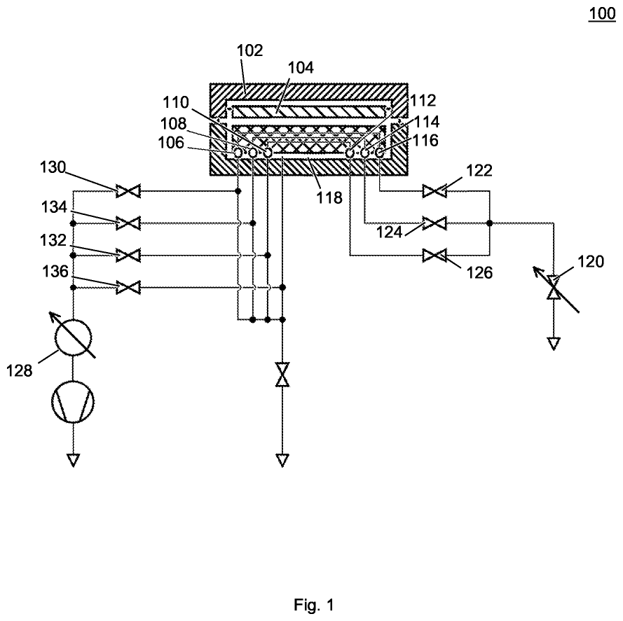

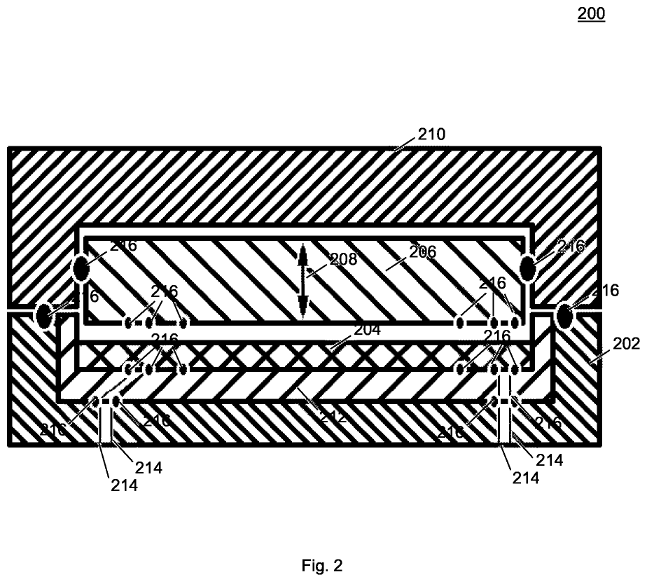

FIG. 1 shows a sketch of the schematic design of a measurement arrangement comprising the apparatus according to the invention;

FIG. 2 shows a sketch of a section through a design of an apparatus according to an embodiment;

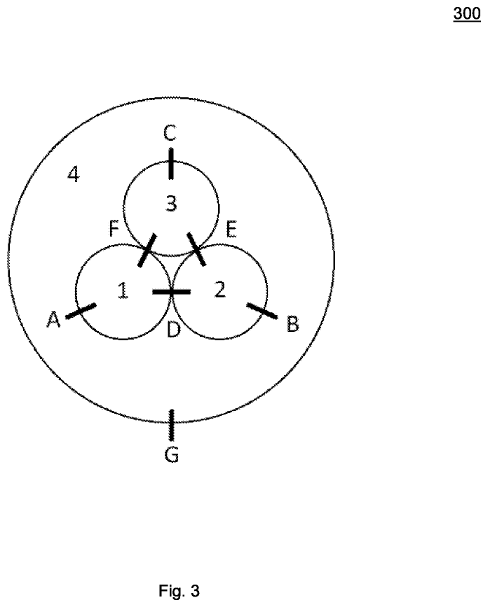

FIG. 3 schematically shows a model of a channel-containing component within the apparatus according to an embodiment;

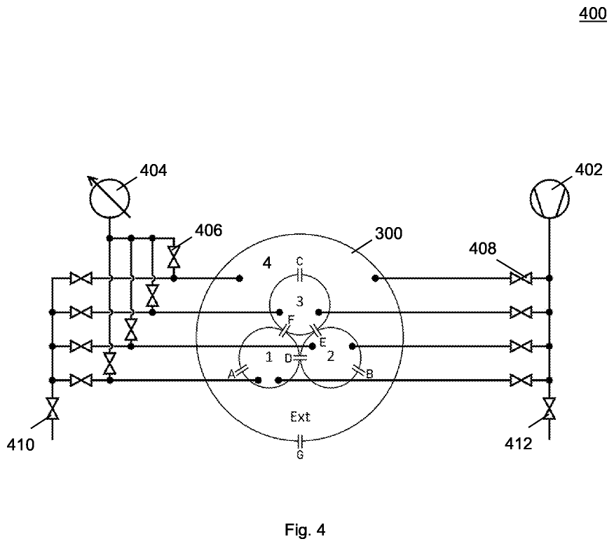

FIG. 4 shows a possible design according to an embodiment with the channel-containing component from FIG. 3;

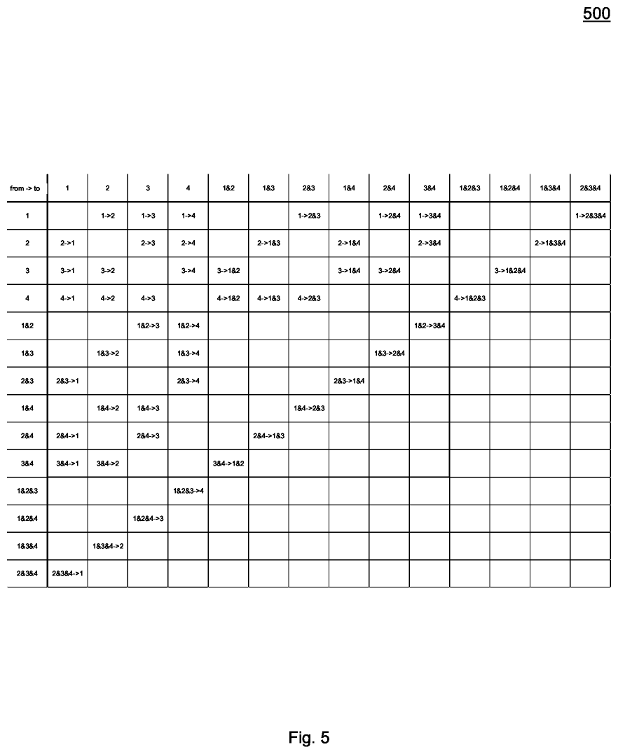

FIG. 5 schematically shows all the measurement configurations according to an embodiment for a channel-containing component in an apparatus configured for leakage measurement;

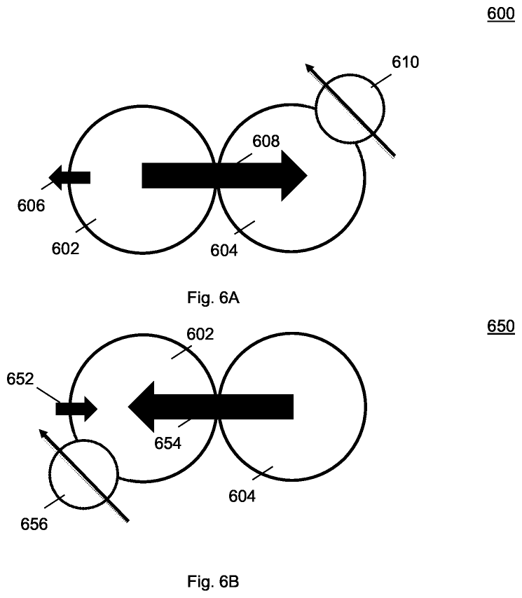

FIG. 6A and FIG. 6B schematically show measurement configurations according to an embodiment that only show known influences of the leakage paths;

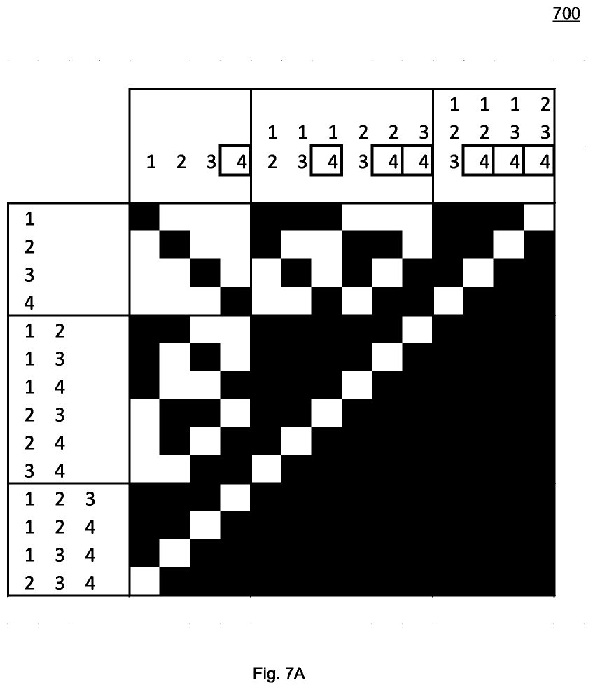

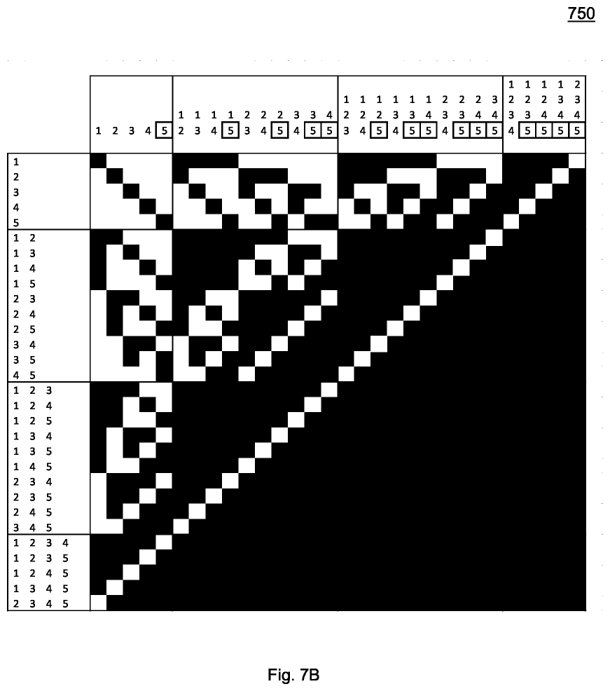

FIG. 7A, FIG. 7B show, by way of example, the locating of influence-free measurement configurations;

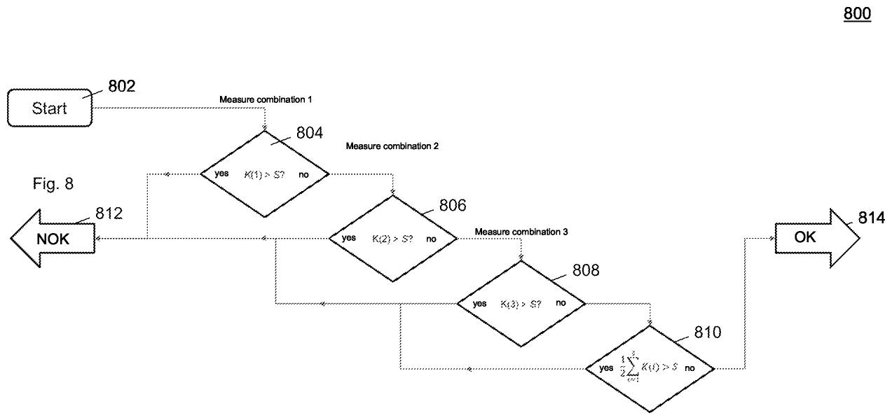

FIG. 8 shows a flowchart of a sequence of a complete test of a channel-containing plate with three channels and a surrounding measurement volume according to an embodiment; and

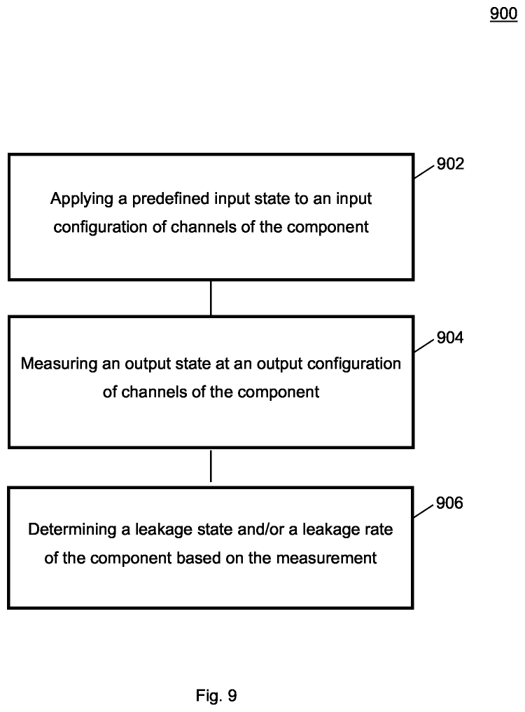

FIG. 9 shows a flowchart of a method according to the invention.

FIG. 1 shows a sketch of the schematic design of a measurement arrangement 100 comprising the apparatus according to the invention. An apparatus 102 for the leak testing and/or leakage measurement of a component 104 comprising a plurality of channels is shown. In this respect, the component 104 can, for example, be a bipolar plate and the channels can each be associated with two openings in the bipolar plate (for example, an input and an output). For example, the bipolar plate can have six openings to conduct a coolant (with input 112 and output 106), an oxidizing agent (with input 114 and output 108) and a reducing agent (with input 116 and output 110) through the bipolar plate. The component 104 can be at least partly enclosed in the apparatus 102 by a surrounding volume 118.

In one embodiment, an input state can be applied to at least a subset of the respective inputs 112, 114, 116 of the channels, for example by a pressure specification from a pressure source 120. Selected channel inputs 112, 114, 116 can be connected to the pressure source 120 by means of valves 122, 124, 126.

In one embodiment, an output state can be measured at at least a subset of the respective outputs 106, 108, 110 of the channels and/or at the surrounding volume 118, for example by means of a measurement device 128. Selected channel outputs 106, 108, 110 and/or the surrounding volume 118 can be connected to the measurement device 128 by means of valves 130, 132, 134, 136.

The apparatus for measuring and/or testing the leak-tightness of at least one channel-containing component can have an at least three-part design comprising a pick-up element, a closure element and a pressure element. The pick-up element and the closure element can be configured to form a common gas-tight sealing surface. The pick-up element and the closure element can be arranged as releasably movable relative to one another. The pick-up element can be configured to pick up at least one channel-containing component in a form-fitting manner. The pressure element can be configured to connect the channel-containing component to the pick-up element in a force-transmitting manner. The apparatus can include at least two connections and lines that are suitable for conducting gaseous media and at least one measurement device.

The measurement device can be configured to analyze a gaseous medium in terms of its properties and/or its movement state. The analysis of the movement state can, for example, be understood as a flow measurement and the analysis of the properties of the gaseous medium can be understood as an analysis of a measurement device that is configured to determine the material composition of the gaseous medium; for example, a mass spectrometer can be used for this purpose.

In embodiments, the measurement devices suitable for determining the material composition are selected from: Mass spectrometers, in particular sector field mass spectrometers and QMS (quadrupole mass spectrometers), OES (optical emission spectroscopes), ΔP (pressure change or differential pressure) measurement devices, flow meters of different inlet pressure ranges against different outlet pressure ranges, wherein the pressure ranges can be more than 10⁻⁷ hPa and, for example, less than 5 MPa absolute pressure, for example more than 10⁻⁶ hPa and less than 4.5 MPa, for example more than 10⁻⁴ hPa and less than 4 MPa.

The gaseous media are in this respect preferably selected from ammonia, hydrocarbons, fluorinated hydrocarbons, hydrofluoroolefins, water vapor, nitrogen, air and oxygen and from test gases that have a molar mass of 4 u, 3 u or 2 u, where u symbolizes the unified atomic mass unit.

With the apparatus according to the invention, in particular by using the pressure element, a thickness-independent clamping of the bipolar plate (BPP) can be achieved with a simultaneous sealing of the BPP environment. Furthermore, that force which the BPP experiences through the pressure element and the pick-up element can advantageously be adapted in a modular manner.

According to an embodiment, the internal channels of the inserted bipolar plate can be pressurized and/or evacuated in a targeted manner. This enables the targeted pressurization of every conceivable measurement configuration. A pressurization of the BPP environment during the measurement or test operation is thus also possible.

FIG. 2 shows a sketch of a section 200 through a design of an apparatus according to an embodiment. The multi-part design comprising a pick-up unit 202 (which can serve as a bed for the component 204, for example a bipolar plate), a pressure element 206 (which can, for example, be designed as a piston) and a closure element 210 (which can also serve as a piston guide) is shown here. For example, the channel-containing component 204 can have six openings to lead through a coolant, an oxidizing agent and a reducing agent. These openings are each connected to one another in pairs by channels. The pressure element 206 can move along a direction of movement 208 to press the component 204 securely and with a settable force against the pick-up element 202, irrespective of the thickness of the component 204.

To be able to measure components 204 with different channels (for example with different numbers of channels or with different positions at which the channels are guided out of or into the component 204), an adapter plate 212 can be provided between the pick-up unit 202 and the component 204. The adapter plate 212 can direct the inputs or outputs 214 of the pick-up unit 202 to the respective channel inputs and channel outputs at the component 204.

FIG. 2 shows various seals 216 that seal the individual components of the apparatus and the component 204.

The BPP can be areally inserted into an adapter receiver. This receiver can include openings and at least one seal that is suitable for establishing a gas-tight connection in a force-transmitting manner. The openings of the adapter receiver for contacting the openings of the BPP can be guided through the adapter plate and can in turn lead into openings at the oppositely disposed side of the adapter receiver. These openings can always be the same for different adapter receivers and can be designated as standardized adapter openings.

In one embodiment, the apparatus comprises a chamber base and a chamber cover. The chamber base can in this respect be provided with openings, wherein these openings are designed as a counterpart to the adapter openings and correspond to the nominal width of the standardized adapter openings. In one embodiment example, the nominal widths of the openings are ¼″, which corresponds to a diameter of approximately 6 mm.

In one embodiment, the channel-containing components are designed as flat. For example, the channel-containing components are bipolar plates, which can also be referred to as BPPs. Bipolar plates are essential components of fuel cells. Within the meaning of the invention, a fuel cell known per se is understood as an apparatus that is capable of converting a portion of the energy from the reaction of an oxidizing agent (e.g. oxygen) with a reducing agent (e.g. hydrogen) directly into electrical energy. Technical devices that usually work with highly flammable media are subject to high safety standards and to corresponding norms.

Furthermore, as a non-exhaustive example, monoplates are to be understood as channel-containing components. Bipolar plates are often joined from said monoplates.

The existing systems for carrying out measurements and/or tests in accordance with the currently applicable norms are technically complex and often time-consuming on an industrial scale.

No adaptive apparatus are known from the prior art. Due to its modular design, the subject according to the invention includes the possibility of mechanical adapters. In this respect, when using modified geometries of the channel-containing components, the receivers can be easily exchanged by the subject according to the invention. This is advantageous since the service life in an industrial use is increased in this way. Furthermore, the maintenance and cleaning effort is reduced since the adaptive receiver in this modularly designed system can be cleaned and maintained separately from the rest of the system.

With the apparatus according to the invention, the clamping force of the apparatus for sealing the channel-containing component can be variably settable. This enables a continuous optimization of the test parameters without a new production. Due to this variable clamping force, varying test conditions within a measuring cycle can furthermore be reacted to, whereby a particularly gentle testing of bipolar plates is made possible. This reduces the probability of test-related material damage to the bipolar plates.

Furthermore, the apparatus offers the advantage that the environment of the bipolar plate can be pressurized and evacuated.

The adaptive apparatus further enables the testing of test objects with a high tolerance range without conversion or further measures.

End plates are often somewhat thicker. These plates can be checked in the same receiver without additional conversions, set-up times, expulsions or other measures.

FIG. 3 schematically shows a model 300 of a channel-containing component within the apparatus according to an embodiment. The channel-containing component in this respect includes the channels 1, 2 and 3 and a surrounding volume 4. The theoretically possible leakage paths are symbolized by the letters A, B, C, D, E, F and G. In this respect, A symbolizes the leakage path between channel 1 and the surrounding volume 4, B the leakage path between channel 2 and the surrounding volume, C the leakage path between channel 3 and the surrounding volume, D the leakage path between channel 1 and channel 2, E the leakage path between channel 2 and channel 3, and F the leakage path between channel 1 and channel 3.

Furthermore, a leakage path G between the surrounding volume of the apparatus and an environment of the apparatus is shown in FIG. 3. However, this leakage path can be left out of consideration if it is ensured that the apparatus is leak-tight against the environment.

FIG. 4 shows a possible design 400 according to an embodiment with the channel-containing component 300 from FIG. 3. A pressure source 404 is connected to the component 300 by means of valves. For example, the pressure source 404 is connected to the surrounding volume 4 by means of the valve 408. A measurement apparatus 402 is connected to the component 300 by means of valves. For example, the measurement apparatus 402 is connected to the surrounding volume 4 by means of the valve 406. The valves 410 and 412 can be used to ventilate the apparatus according to the design 400 shown. Various measurement configurations can be measured using suitable valve settings (i.e. settings of the valves to block or guide or conduct through). The measurement of a measurement configuration is in this respect understood as the application of a medium under a given pressure to at least one channel, wherein at least one further channel, which is not identical to the at least one pressurized channel, is measured by a suitable measurement apparatus. In this respect, the physical detection limit has an influence on the suitability of the measurement means.

In one embodiment, a method for measuring the leakage paths and/or for testing the leak-tightness of channel-containing components comprises the following steps:
1. Determining all the input and output configurations,
2. Selecting influence-free measurement configurations and
3. Measuring the selected measurement configurations.

When viewed together, the measurement results each reproduce different leakage paths. Using the following equations, the channel-specific leakage rates that are not directly accessible by measurement can be inferred from the measurement results.

Influence-free measurement configurations can be converted into a matrix notation. In this respect, the designations of rows and columns in each case correspond to the numbering of the individual channels or cavities. In the following non-limiting example, the leakage paths are symbolized by the letters A, B, C, D, E and F as well as G, such as is illustrated in FIG. 3. The letters A, B and C each symbolize the leakage path from a channel into the surrounding volume; D, E and F here reflect the leakage paths between individual channels without the surrounding volume.

The letter G here symbolizes the leakage path that is present between the measurement apparatus and the environment. This leakage path is a characteristic of the apparatus used and is therefore neglected in the following.

Thus, a matrix representation with the elements mᵢⱼ for the interaction of the channels with pressurization and the channels of an attached measurement device is generalized as follows:

$$[ Pres s u re \to Measurement device ] = ( \begin{matrix}0 & D & F & A \\ D & 0 & E & B \\ F & E & 0 & C \\ A & B & C & 0\end{matrix} ) ,$$

where the following applies to the leakage rate L of all the leakage paths:

$$L = \frac{1}{2} \cdot {\sum }_{i , j}^{n} {m}_{i j} .$$

In the case of the influence-free measurement configurations, the coefficients of the entries in such a matrix are exclusively the values 1 and 0. The value 1 is in this respect used for a possible leakage path, the value 0 for a definite absence of such a path.

Outside of the influence-free measurement configurations, the coefficient of a leakage path cannot be clearly set to one of the values 0 or 1 since processes such as diffusion here enable crosstalk between the leakage paths.

It is not always possible to measure the leakage paths individually (i.e. A, B, C, D, E and F individually in each case) due to their interdependence.

Only the leakage path G can be individually determined, for example by a so-called background measurement, since it is a characteristic of the apparatus. This leakage path must in particular be considered if the surrounding volume is the measured volume. In this case, the following applies to the entire leakage path:

$${L}^{′} = L + L ( G ) .$$

L(G) represents the individually measured leakage rate of the leakage path G.

At least three leakage paths are always assigned to one channel each.

For example, in the notation introduced, the pressurizations of one channel each are shown in an influence-free configuration:
Channel 1→Complement (1→2 & 3 & 4)

$$[ 1 \to 2 \& 3 \& 4 ] = ( \begin{matrix}0 & D & F & A \\ D & 0 & 0 & 0 \\ F & 0 & 0 & 0 \\ A & 0 & 0 & 0\end{matrix} )$$

Channel 2→Complement (2→1 & 3 & 4)

$$[ 2 \to 1 \& 3 \& 4 ] = ( \begin{matrix}0 & D & 0 & 0 \\ D & 0 & E & B \\ 0 & E & 0 & 0 \\ 0 & B & 0 & 0\end{matrix} )$$

Channel 3→Complement (3→1 & 2 & 4)

$$[ 3 \to 1 \& 2 \& 4 ] = ( \begin{matrix}0 & 0 & F & 0 \\ 0 & 0 & E & 0 \\ F & E & 0 & C \\ 0 & 0 & C & 0\end{matrix} )$$

Channel 4→Complement (4→1 & 2 & 3)

$$[ 4 \to 1 \& 2 \& 3 ] = ( \begin{matrix}0 & 0 & 0 & A \\ 0 & 0 & 0 & B \\ 0 & 0 & 0 & C \\ A & B & C & 0\end{matrix} )$$

In none of the above configurations can a state be reached in which one leakage path each can be clearly measured. According to the invention, however, all six possible leakage paths can be tested for leaks by a small number of measurements, i.e. a leak test can be carried out for each leakage path using fewer than six measurements.

This procedure is first demonstrated using the present example of three channels and a surrounding volume:

For this purpose, the following three measurement configurations (i.e. the following three combined leakage paths) are, for example, examined: 14->23, 24->13 and 34->12, where the digits before the arrow in each case indicate the channels for which an input state is applied (i.e. the input configuration) and the digits after the arrow indicate the channels at which measurements are taken (i.e. the output configuration). For example, “14->23” therefore means that a common input state is applied at the channels 1 and 4 and that measurements are taken at the channels 2 and 3.

The following matrices then result for these three configurations:

$$1. [ 14 \to 23 ] = ( \begin{matrix}0 & 1 D & 1 F & 0 \\ 1 D & 0 & 0 & 1 B \\ 1 F & 0 & 0 & 1 C \\ 0 & 1 B & 1 C & 0\end{matrix} )$$

$$2. [ 24 \to 13 ] = ( \begin{matrix}0 & 1 D & 0 & 1 A \\ 1 D & 0 & 1 E & 0 \\ 0 & 1 E & 0 & 1 C \\ 1 A & 0 & 1 C & 0\end{matrix} ) and$$

$$3. [ 34 \to 12 ] = ( \begin{matrix}0 & 0 & 1 F & 1 A \\ 0 & 0 & 1 E & 1 B \\ 1 F & 1 E & 0 & 0 \\ 1 A & 1 B & 0 & 0\end{matrix} ) .$$

This results in an entry of 1 in the matrix in each case for those elements in which the row number corresponds to a channel from the input configuration and the column number corresponds to a channel from the output configuration. This also makes it clear why there can only be 0 as an entry on the main diagonal (because no channel can be included in both the input configuration and the output configuration in the case of influence-free measurement configurations).

For example, for the measurement configuration 14->23, the entries at the following entries of the matrix are equal to 1:
Row 1, column 2,
Row 1, column 3,
Row 4, column 2,
Row 4, column 3.

In addition, the entries resulting from transposition (i.e. by “swapping” row and column) are equal to 1. In the example of the measurement configuration 14->23, they are the following entries of the matrix:
Column 1, row 2,
Column 1, row 3,
Column 4, row 2,
Column 4, row 3.

All other entries are 0.

In this respect, the sum of these matrices for the selected measurement configurations results in the following matrix:

$$[ 14 \to 23 ] + [ 24 \to 13 ] + [ 34 \to 12 ] = ( \begin{matrix}0 & 2 D & 2 F & 2 A \\ 2 D & 0 & 2 E & 2 B \\ 2 F & 2 E & 0 & 2 C \\ 2 A & 2 B & 2 C & 0\end{matrix} ) .$$

The leakage rate of all the leakage paths is thus

$$L = \frac{1}{2} \cdot ( 2 A + 2 B + 2 C + 2 D + 2 E + 2 F ) .$$

With regard to the test procedure, it should be noted that each leakage path has exactly 2 components in the resulting sum. Furthermore, all possible leakage paths are covered by the 3 influence-free measurement configurations from the example. Thus, all 6 leakage paths are completely determined with the measurement of 3 influence-free configurations.

By further analyzing the previously generated matrices, it can be seen that the measurement after two measurement configurations is sufficient to have integrally measured all 6 leakage paths. In the sum of the two matrices that correspond to the two measurement configurations, this is symbolized in that no entry beyond the trace is identical to 0.

Thus, two measurements (corresponding to two measurement configurations from the above three measurement configurations 14->23, 24->13 and 34->12) are sufficient to enable a test. In this example, two measurements can be viewed as a sufficient test criterion, for example:

$$[ 14 \to 23 ] = ( \begin{matrix}0 & 1 D & 1 F & 0 \\ 1 D & 0 & 0 & 1 B \\ 1 F & 0 & 0 & 1 C \\ 0 & 1 B & 1 C & 0\end{matrix} ) and$$

$$[ 34 \to 12 ] = ( \begin{matrix}0 & 0 & 1 F & 1 A \\ 0 & 0 & 1 E & 1 B \\ 1 F & 1 E & 0 & 0 \\ 1 A & 1 B & 0 & 0\end{matrix} )$$

results in:

$$[ 14 \to 23 ] + [ 34 \to 12 ] = ( \begin{matrix}0 & 1 D & 2 F & 1 A \\ 1 D & 0 & 1 E & 2 B \\ 2 F & 1 E & 0 & 1 C \\ 1 A & 2 B & 1 C & 0\end{matrix} ) .$$

With these two measurement configurations (14->23 and 34->12), it can therefore first be checked whether there is a leak or not. If neither of the two measurement configurations has a leak, it can be concluded that the component as a whole does not contain a leak.

If at least one of the two measurement configurations contains a leak (i.e. if there is at least one leak from a channel from the input configuration to a channel from the output configuration of the respective measurement configuration), a further determination and quantification of the leakage paths can take place.

For the exact determination and quantification of the leakage paths, a measurement configuration can then be found that offsets the influences of the leakage paths against each other in order to finally determine the size of an individual leakage path.

For example, the following four measurement configurations can be considered:

$$4. [ 4 \to 123 ] = ( \begin{matrix}0 & 0 & 0 & 1 A \\ 0 & 0 & 0 & 1 B \\ 0 & 0 & 0 & 1 C \\ 1 A & 1 B & 1 C & 0\end{matrix} )$$

$$5. [ 234 \to 1 ] = ( \begin{matrix}0 & 1 D & 1 F & 1 A \\ 1 D & 0 & 0 & 0 \\ 1 F & 0 & 0 & 0 \\ 1 A & 0 & 0 & 0\end{matrix} )$$

$$6. [ 134 \to 2 ] = ( \begin{matrix}0 & 1 D & 0 & 0 \\ 1 D & 0 & 1 E & 1 B \\ 0 & 1 E & 0 & 0 \\ 0 & 1 B & 0 & 0\end{matrix} )$$

$$7. [ 124 \to 3 ] = ( \begin{matrix}0 & 0 & 1 F & 0 \\ 0 & 0 & 1 E & 0 \\ 1 F & 1 E & 0 & 1 C \\ 0 & 0 & 1 C & 0\end{matrix} ) .$$

By suitably combining equations 1, 2, 3, 4, 5, 6 and 7, the contributions of the desired leakage path can be determined.

For example, without being limited to this, the contribution of A is now to be determined. This can, for example, take place by the following three equations 8, 9 and 10:
8. Sum of the equations 5, 2, 3, 4;
9. Sum of the equations 6, 7, 1; and
10. Difference of the equations 9 and 8.

The equations then read as follows:

$$8. [ 5. + 2. + 3. + 4 . ] = ( \begin{matrix}0 & 2 D & 2 F & 4 A \\ 2 D & 0 & 2 E & 2 B \\ 2 F & 2 E & 0 & 2 C \\ 4 A & 2 B & 2 C & 0\end{matrix} )$$

$$9. [ 6. + 7. + 1. ] = ( \begin{matrix}0 & 2 D & 2 F & 0 \\ 2 D & 0 & 2 E & 2 B \\ 2 F & 2 E & 0 & 2 C \\ 0 & 2 B & 2 C & 0\end{matrix} )$$

$$10. [ 8. - 9 . ] = ( \begin{matrix}0 & 0 & 0 & 4 A \\ 0 & 0 & 0 & 0 \\ 0 & 0 & 0 & 0 \\ 4 A & 0 & 0 & 0\end{matrix} )$$

Equation 10 now only includes parts of 4*A. The leakage path A is thus determined. Similarly, for example, but without being limited thereto, the contribution of E is now also to be determined. The following equations can be used for this purpose:

$$11. [ 6. + 7. + 3. + 2 . ] = ( \begin{matrix}0 & 2 D & 2 F & 2 A \\ 2 D & 0 & 4 E & 2 B \\ 2 F & 4 E & 0 & 2 C \\ 2 A & 2 B & 2 C & 0\end{matrix} ) and$$

$$12. [ 5. + 2. + 3. + 4 . ] = ( \begin{matrix}0 & 2 D & 2 F & 2 A \\ 2 D & 0 & 0 & 2 B \\ 2 F & 0 & 0 & 2 C \\ 2 A & 2 B & 2 C & 0\end{matrix} )$$

results in:

$$13. [ 1 1. - 12. ] = ( \begin{matrix}0 & 0 & 0 & 0 \\ 0 & 0 & 4 E & 0 \\ 0 & 4 E & 0 & 0 \\ 0 & 0 & 0 & 0\end{matrix} ) .$$

Here, too, the leakage path E is completely determined by 4*E, as can be seen from equation 13.

It turns out that one equation each can be found for one leakage path each.

A generalization can be derived from the matrix notation: A set of measurement configurations is selected such that, in the sum of the selected configurations, each matrix entry beyond the trace at least includes the value 1.

A preferred selection rule here comprises the generalization to a number of n channels, where n is a natural number greater than or equal to 2. A respective two channels are set to the same state (for example, pressure or measurement), wherein one of the channels is always the surrounding channel n. The complementary channels are then in the respective other state.

For example, and without limitation, the channels 1, 2, 3, 4, . . . , and n−1, always together with the surrounding channel n, are successively brought to a predefined input state (for example pressed).

The sum of the coefficient matrices for the corresponding measurement configurations—a set—results in the general form:

$$Sum of the set = ( \begin{matrix}0 & 2 & 2 & … & n - 2 \\ 2 & 0 & 2 & … & n - 2 \\ 2 & 2 & 0 & … & n - 2 \\ ⋮ & ⋮ & ⋮ & ⋱ & n - 2 \\ n - 2 & n - 2 & n - 2 & … & 0\end{matrix} ) .$$

According to this procedure, it is possible:
to generate one test procedure each with a minimum number of measurement configurations (i.e. one set) and
to determine one set each of equations to find each individual leakage rate of a system of n channels.

The individual steps are explained in more detail below.

### 1. Determining all the Input and Output Configurations:

The number of all possible input configurations or all possible output configurations can be described mathematically by the number of combinations of the kth class of n different elements without repetition. In this respect, n symbolizes the total number of channels including a surrounding volume. The kth class is the number of those channels that can be pressurized and/or that can be combined to form a measurement volume. The measurement volume can include all channels (or a subset thereof) of the component and/or a surrounding volume (which can also be referred to as the surrounding measurement volume) that are directly connected to a measurement device. The number is thus calculated using the binomial coefficients

$$( \begin{matrix}n \\ k\end{matrix} ) = ( n over k ) ,$$

where it applies that k assumes all natural numbers between 1 and n−1 (because at least one channel is present in the corresponding input or output combination, and because it makes no sense that all n−1 channels and simultaneously the surrounding volume are included in the input or output configuration). The sum of the binomial coefficients determined from these values then initially reflects the number of possible channel combinations. This sum can be specified as 2ⁿ−2.

In a non-exhaustive example, for three (3) channels and exactly one surrounding volume, n=4 results. Thus, the values for k={1;2;3}. This results in (4 over 1)=4; (4 over 2)=6 and (4 over 3)=4, with the result that there are 4+6+4=14 (=2⁴−2) possible combinations of the channels in this case: 4 possibilities to connect one channel each, 6 possibilities to connect two channels each, and 4 possibilities to connect 3 channels each.

### 2. Selecting Influence-Free Measurement Configurations:

The combinations of all possible input configurations with all possible output configurations also include those where the combination of the channels to be pressurized is complementary to the combination of the channels to be measured. These combinations are referred to as influence-free combinations. In the influence-free combinations, all flowed-through leakage paths lead directly into the measurement volume; all possible leakage paths are therefore measured at the same time. The measurement signal thus corresponds to the sum of the leakage rates of the individual leakage channels.

To determine the influence-free measurement configurations, the permutations of all possible channels are interpreted as digits and noted such that the sequence of digits represents the smallest possible number. In a non-exhaustive example, a measurement configuration is 431->65. The smallest possible digits are thus 134 and 56. A measurement configuration can therefore be written as “Input configuration->Output configuration”.

All input configurations represented in this way are entered row-wise in ascending order into a grid—while avoiding duplication. These same numbers (which represent the output configuration) are entered column-wise in ascending order from left to right. The resulting grid or the resulting matrix (in which each matrix entry, i.e. each element of the matrix, represents a measurement configuration resulting from the row and column) can now be evaluated. If numbers with identical digits cross (i.e. if a channel is included in both the input configuration and the output configuration according to the corresponding matrix entry), this is not a valid measurement configuration. If numbers cross that are different in each of their digits (i.e. in which no channel is simultaneously included in the input configuration and the output configuration), this is a permissible measurement configuration. With this procedure, a diagonal is formed within this grid that is simultaneously also the longest diagonal in this illustration. This diagonal shows those influence-free measurement configurations in which each channel and the surrounding volume are simultaneously included in either the input configuration or the output configuration. The row entries can in this respect represent the channels to be filled with test gas and the column entries symbolize a measurement volume.

In a non-exhaustive example, the leakage path into the outer measurement volume is here preferably always symbolized by the largest digit. The leakage into the surrounding measurement volume is given such special importance that selected configurations always have the largest digit in the measurement volume.

FIG. 5 schematically shows all the measurement configurations 500 according to an embodiment for a channel-containing component in an apparatus configured for leakage measurement, wherein the channel-containing component has three channels 1, 2 and 3 and is embedded in a volume 4. One such component is shown in FIG. 3, for example.

FIG. 6A and FIG. 6B schematically show measurement configurations 600 and 650 according to an embodiment that only show known influences of the leakage paths. A first channel 602 and a second channel 604 are shown in FIG. 6A. Here, the case should be shown in which the first channel has a leakage both with respect to a surrounding volume and with respect to the second channel 604.

However, if, as in FIG. 6A, a measurement apparatus 610 is connected to the second channel 604, only a leakage 608 of the first channel 602 to the second channel 608 can thereby be determined, but not a leakage 606 from the first channel 602 to the surrounding volume.

If, as in FIG. 6B, a measurement apparatus 656 is connected to the first channel 602, a leakage 654 of the first channel 602 to the second channel as well as a leakage 652 from the first channel 602 to the surrounding volume 604 can thus be determined.

The locating of influence-free measurement configurations is shown by way of example in FIGS. 7a and 7B. The numbers at the rows symbolize the configuration of the channels that are filled with a test gas (i.e. the input configurations). The numbers to be read vertically at the columns in each case symbolize the channels that are interconnected to form a measurement volume (i.e. the output configurations).

FIG. 7A shows a diagram 700 for a system, comprising a channel-containing component with 3 internal channels and an external surrounding volume, in which the possible measurement configurations are shown graphically. This corresponds to the arrangement as in FIG. 5, but with a different order of the rows and columns. The blackened fields represent combinations that are not to be measured. The white fields represent those paths that are suitable for measurement. The diagonal that runs from the lower left corner of the diagram to the upper right corner of the diagram (i.e. the secondary diagonal of the matrix shown) in this respect maps the influence-free measurement configurations in which each channel occurs in the measurement configuration.

FIG. 7B shows a diagram 750 with possible measurement configurations for a system comprising a channel-containing component with 4 internal channels and an external surrounding volume.

### 3. Measuring the Selected Measurement Configurations

For a system comprising n−1 channels and a surrounding measurement volume, the number of leakage paths L to be expected can be expressed by the equation

$$L = 0.5 ( {n}^{2} - n ) .$$

The number of influence-free measurement configurations K, which include all the channels and the surrounding measurement volume, develops according to the equation:

$$K = {\sum }_{k = 1}^{n - 1} ( \begin{matrix}n \\ k\end{matrix} ) = {2}^{n} - 2 .$$

Thus, even the influence-free configurations grow faster than the leakage paths. From these configurations, further configurations can now be selected so that all relevant leakage paths can be measured integrally.

This selection can in this respect take place such that, in a set of influence-free measurement configurations, each channel is represented at least twice. The surrounding measurement volume can be included in each configuration.

For example, and without being limited thereto, a set for a system of 3 channels with a surrounding measurement volume can look as follows:

| Test gas inlet: | Measurement volume: |
|---|---|
| 1 & 2 | 3 & 4 |
| 2 & 3 | 1 & 4 |
| 3 & 1 | 2 & 4 |

“Test gas inlet” can in this respect be understood as an input configuration.
“Measurement volume” can be understood as an output configuration.

With this set (i.e. with this subset of measurement configurations, in particular as a subset of influence-free measurement configurations), a multiple of the integral leakage rate can now be determined and time-consuming individual measurements can thus be replaced, as described above as an example for the case of three channels and in general for the case of n−1 channels and a respective surrounding volume.

FIG. 8 shows a flowchart 800 of a sequence of a complete test of a channel-containing plate with three channels and a surrounding measurement volume according to an embodiment. After starting the test in 802, the combination 1 previously defined according to the method is first measured in 804. If the measurement result is above a given threshold value, the test is ended in 812 with the result “NOK” (not OK, i.e. there is an impermissibly high leakage). If the threshold value is fallen below, the combination 2 previously defined according to the method is measured in 806. If this measurement result is above the given threshold value, the test is ended in 812 with the result “NOK”. If the threshold value is fallen below, the combination 3 previously defined according to the method is measured in 808. If the measurement result is above a given threshold value, the test is ended in 812 with the result “NOK”. If the threshold value is fallen below, the sum of all the previous measurement values is calculated in 810. If this sum exceeds a predefined value (for example, twice the threshold value), the test is ended in 812 with “NOK”. Otherwise, the test is concluded in 814 with the result “OK” (in order, i.e. there is no impermissibly high leakage).

The method according to the invention offers the advantage over a common procedure that a significant reduction in measurement times can be achieved. A common procedure is characterized in that a respective measurement examines a supposed leakage path. With this approach, a plurality of possible leakage paths must be measured to identify the leakage path with the highest leakage rate, for example. Once such a leakage path has been found using a suitable measurement configuration, the level of the measured signal can be used to check whether the test has been passed or not.

According to various embodiments, due to the targeted selection of measurement configurations and the subsequent measurement of these selected measurement configurations in combination with a sequential exposure of the test objects to different test gases, e.g. helium (mass 4) in different concentrations, hydrogen (mass 2) in different concentrations and a test gas with the mass 3 in different concentrations, the respective subsequent test gas can act as a purge gas for the test gas used in the previous process step. Slow gas exchange times are therefore replaced by fast switching times at the detector used.

Thus, shorter cycle times and higher throughputs can be achieved in an industrial environment. The latter represents a major economic advantage. This is advantageous in that a high degree of cost-effectiveness can thereby be achieved, in particular since an often time-consuming test or component qualification can be significantly accelerated and the price of the tested product can be reduced.

In simple terms, the method according to the invention does not wait for signal recovery for a test gas with a certain mass, but simply switches to a different measurement configuration with another test gas.

FIG. 9 shows a flowchart 900 that illustrates a method for the leak testing and/or leakage measurement of a component comprising a plurality of channels according to an embodiment. In 902, a predefined input state is applied to an input configuration of channels of the component. In 904, an output state is measured at an output configuration of channels of the component. In 906, a leakage state and/or a leakage rate of the component is determined based on the measurement. The input configuration includes at least two channels of the component and the output configuration includes at least one other channel of the component; or the input configuration includes at least one channel of the component and the output configuration includes at least two other channels of the component.

In one embodiment, the input state includes or is a predefined pressure and/or a predefined concentration and/or a predefined chemical element and/or a predefined chemical compound and/or a predefined mixture of chemical substances, and the measurement of the output state includes or is a detection of a pressure and/or a concentration and/or the predefined chemical element and/or the predefined chemical compound and/or the predefined mixture of chemical substances.

In one embodiment, the application and the measurement are performed for a plurality of different measurement configurations, wherein each measurement configuration includes a specific input configuration and a specific output configuration, wherein the leakage state and/or the leakage rate of the component is/are determined based on the application and the measurement for the plurality of different measurement configurations.

In one embodiment, the respective input state for consecutive measurements includes or is different pressures and/or different concentrations and/or different chemical elements and/or different chemical compounds and/or different mixtures of chemical substances.

In one embodiment, the plurality of different measurement configurations are determined such that each channel occurs in combination with every other channel in at least one measurement configuration of the plurality of measurement configurations.

In one embodiment, a respective leakage rate is determined for the plurality of measurement configurations and a leakage rate between two channels is determined based on the respective leakage rates for the plurality of measurement configurations.

With the apparatus and methods according to various embodiments, an adaptation to changing geometries in the case of changing channel-containing components, for example bipolar plates, is possible. Furthermore, a pressurization of the environment of the channel-containing component can take place.

It is understood that all the embodiments described by way of example for a BPP can generally be applied to any channel-containing component.

### REFERENCE NUMERAL LIST

100 schematic design of a measurement arrangement according to an embodiment
102 apparatus according to an embodiment
104 component
106, 108, 110, 112, 114, 116 channels
118 surrounding volume
120 pressure specification
122, 124, 126 valves
128 measurement device
130, 132, 134, 136 valves
200 section through a design of an apparatus according to an embodiment
202 pick-up unit
204 component
206 pressure element
208 direction of movement
210 closure element
212 adapter plate
214 input/output
216 seal
300 model of a channel-containing component within the apparatus according to an embodiment
1, 2, 3 channels
4 surrounding volume
A, B, C, D, E, F, G theoretically possible leakage paths
400 possible design according to an embodiment with the channel-containing component from FIG. 3.
402 pressure source, for example, a vacuum pump for generating the pressure required for the measurement
404 measurement apparatus
406, 408, 410, 412 valves
500 all the measurement configurations according to an embodiment
600 measurement configuration according to an embodiment
602 first channel
604 second channel
606 leakage
608 leakage
610 measurement apparatus
650 measurement configuration according to an embodiment
652 leakage
654 leakage
656 measurement apparatus
700, 750 illustration of a locating of influence-free measurement configurations
800 flowchart of a sequence of a complete test of a channel-containing plate with three channels and a surrounding measurement volume according to an embodiment
802 start
804 measurement of combination 1
806 measurement of combination 2
808 measurement of combination 3
810 formation of the sum of all the measurement values
812 result “NOK”
814 result “OK”
900 flowchart that illustrates a method for the leak testing and/or leakage measurement of a component comprising a plurality of channels according to an embodiment
902 step of applying a predefined input state to an input configuration of channels of the component
904 step of measuring an output state at an output configuration of channels of the component
906 step of determining a leakage state and/or a leakage rate of the component based on the measurement

1. A method for the leak testing and/or leakage measurement of a component comprising a plurality of channels, the method comprising:
applying a predefined input state to an input configuration of channels of the component;
measuring an output state at an output configuration of channels of the component; and
determining a leakage state and/or a leakage rate of the component based on the measurement,
wherein the input configuration has at least two channels of the component and the output configuration has at least one other channel of the component, or wherein the input configuration has at least one channel of the component and the output configuration has at least two other channels of the component.

2. The method according to claim 1,
wherein the input state has a predefined pressure and/or a predefined concentration and/or a predefined chemical element and/or a predefined chemical compound and/or a predefined mixture of chemical substances; and
wherein the measurement of the output state comprises detecting a pressure and/or a concentration and/or the predefined chemical element and/or the predefined chemical compound and/or the predefined mixture of chemical substances.

3. The method according to claim 1,
wherein the application and the measurement are performed for a plurality of different measurement configurations, wherein each measurement configuration has a specific input configuration and a specific output configuration;
wherein the leakage state and/or the leakage rate of the component is/are determined based on the application and the measurement for the plurality of different measurement configurations.

4. The method according to claim 3,
wherein, for consecutive measurements, the respective input state has different pressures and/or different concentrations and/or different chemical elements and/or different chemical compounds and/or different mixtures of chemical substances.

5. The method according to claim 3, further comprising:
determining the plurality of different measurement configurations such that each channel occurs in combination with every other channel in at least one measurement configuration of the plurality of measurement configurations.

6. The method according to claim 3, further comprising:
determining a respective leakage rate for the plurality of measurement configurations; and
determining a leakage rate between two channels based on the respective leakage rates for the plurality of measurement configurations.

7. An apparatus for the leak testing and/or leakage measurement of a component comprising a plurality of channels, said apparatus comprising:
an input;
an output;
a pick-up device configured to:
pick up the component;
connect the input to an input configuration of channels of the component; and
connect the output to an output configuration of channels of the component; and
a measurement device configured to:
apply a predefined input state to the input;
measure an output state at the output; and
determine a leakage state and/or a leakage rate of the component based on the measurement,
wherein the input configuration has at least two channels of the component and the output configuration has at least one other channel of the component, or wherein the input configuration has at least one channel of the component and the output configuration has at least two other channels of the component.

8. The apparatus according to claim 7, further comprising:
a closure element, wherein the pick-up element and the closure element are configured to form a common sealing surface, and wherein the pick-up element and the closure element are arranged as releasably movable relative to one another.

9. The apparatus according to claim 7, further comprising:
a pressure element configured to connect the component to the pick-up element by exerting force on the component towards the pick-up element.

10. The apparatus according to claim 7, further comprising:
an adapter plate comprising connections, which are specific to the component, of channels of the component to the input and the output.

11. The apparatus according to claim 7, further comprising:
valves configured to block or release a connection between the input of the apparatus and channels of the component and between the output of the apparatus and channels of the component.

12. The apparatus according to claim 7,
wherein the measurement device comprises a quadrupole mass spectrometer and/or a time-of-flight mass spectrometer and/or a sector field mass spectrometer and/or a pressure measurement device and/or a differential pressure measurement device and/or a flow measurement apparatus and/or a spectrometer from the group of optical spectrometers.

13. The apparatus according to claim 7,
wherein the measurement device is configured to measure pressure ranges in the range of 10⁻⁷ hPa and 5 MPa, or in the range of 10⁻⁶ hPa and 4.5 MPa, or in the range of 10⁻⁴ hPa and 4 MPa.

14. The apparatus according to claim 7,
wherein the measurement device is configured to measure gaseous media, preferably selected from gaseous refrigerants, ammonia, hydrocarbons, fluorinated hydrocarbons, hydrofluoroolefins, water vapor, nitrogen, air and oxygen and from test gases that have a molar mass of 4 u or 3 u or 2 u.

15. The apparatus according to claim 7,
wherein the channel-containing component has a bipolar plate or a monoplate.

16. The apparatus according to claim 7, wherein the apparatus is configured to carry out a method for the leak testing and/or leakage measurement of the component, the method comprising:
applying a predefined input state to an input configuration of channels of the component;
measuring an output state at an output configuration of channels of the component; and
determining a leakage state and/or a leakage rate of the component based on the measurement,
wherein the input configuration has at least two channels of the component and the output configuration has at least one other channel of the component, or wherein the input configuration has at least one channel of the component and the output configuration has at least two other channels of the component.
